(19) United States
(12) Patent Application Publication
(10) Pub. No.: US 2014/0031056 A1
(43) Pub. Date: Jan. 30, 2014

(54) Method and Node for Intelligent Paging Based on User Location Intelligence

(71) Applicant: Carl Cao, San Jose, CA (US)

(72) Inventor: Carl Cao, San Jose, CA (US)

(21) Appl. No.: 13/557,399

(22) Filed: Jul. 25, 2012

(51) Int. Cl. H04W 24/00

(52) U.S. Cl. 455/456.1

(57) ABSTRACT

A node of a wireless telecommunications network having a UE includes a network interface unit which receives and records each instance of a wireless protocol message, from the UE, to form a connection in the network or to update the network of its location, including time, date, and one or more sectors of the UE when the UE attempt is made: The node includes a Location Intelligence Database (LIDB), in which the recorded UE location information for the message from the UE over time is stored. The node includes a Location Intelligence Processor or LIP, which aggregates the information stored in the LIDB to form a pattern of UE location information by time, date, and sector within the wireless network.

### TECHNICAL FIELD

The present invention is related to determining a location that a UE may be at for paging purposes by using historical pattern information acquired from the UE over time. (As used herein, references to the “present invention” or “invention” relate to exemplary embodiments and not necessarily to every embodiment encompassed by the appended claims.) More specifically, the present invention is related to determining a location that a UE may be at for paging purposes by using historical pattern information of the user's location acquired from the UE over time that is based on time, date, and sector information regarding the UE location.

### BACKGROUND

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Paging is a function for a cellular wireless system to locate individual user equipment (UE) that is currently registered within the system but whose precise location is unknown at a particular time.

This is generally applicable for all 2G, 3G, or 4G wireless networks. Initially, a UE registers with the wireless system, then it may move from one location to another within the network. As a result it is still known system wide, but it may be located within any cell or sector of the wireless network clue to this mobility as shown in FIG. 1.

In order to communicate with the UE, the wireless system needs to page the UE in order to identify the UE at the granularity of an individual cell or sector (henceforth a sector is used to refer to either a cell or a sector) as shown in FIG. 2. A page is sent over the shared or common control channel (CCH) of all the sectors within the wireless system, where the UE may be located.

The UE response to the page identifies the specific sector where it is located. The system can then manage its resources, establish over-the-air connection with the device, and then dedicate resources to support the connection as shown in FIG. 3.

Because the page may be replicated over every control channel in each sector where the UE may be located, in the aggregate, at any time the total number of pages can he large and thus depriving precious RF resources for actual user data transmission. Additionally, there are secondary side-effects of more pages causing UE battery drain and longer delays as each page message in the system retains the UE longer to listen to the system control channels.

It has been a persistent challenge for wireless systems to estimate more precisely where the UE is, and then minimize the number of pages.

The existing techniques for minimizing the pages include distance based paging, last-known location based paging, etc.

None however can be precise as to exploit the intelligence of known data on when and where the UE is usually located.

Human activity is highly predictable; a user's location is highly constant, for example, being at home during certain days, certain hours of the day, and being in the office other days, and other hours. The knowledge of this high constancy should be valuable intelligence such that the specific UE can be paged at a much limited scope and thus freeing up valuable system resources.

It should be noted that computing technology has made location intelligence of a UE much more available and much more affordable with abundance of computer memory.

The current paging techniques fail to utilize the user location intelligence to more precisely identify where the user is located at a certain time. Thus, they are not optimal in saving control channel resources.

### BRIEF SUMMARY OF THE INVENTION

The present invention pertains to a node of a wireless telecommunications network having a UE. The node comprises a network interface unit which receives and records each instance of a wireless protocol message, from the UE, to form a connection in the network or to update the network of its location, including time, date, and one or more sectors of the UE when the UE attempt is made. The node comprises a Location Intelligence Database (LIDB), in which the recorded UE location information for the message from the UE over time is stored. The node comprises a Location Intelligence Processor (LIP), which aggregates the information stored in the LIDB to form a pattern of UE location information by time, date, and sector within the wireless network.

It should be noted that the node herein may be a logical entity with its functions including the LIDB, the LIP, and the PA, distributed amongst two or more physical entities.

The present invention pertains to a node of a wireless telecommunications network having a UE. The node comprises a network interface unit which receives and records each instance of a wireless protocol message, from the UE, to form a connection in the network or to update the network of its location, including time, date, and one or more sectors of the UE when the UE attempt is made. The node comprises a Location Intelligence Database (LIDB), in which UE location information is stored and indexed to a time slot. The node comprises a Paging Agent processing unit (PA), which produces a page request for the UE that is sent from the network interface unit to the UE through the network to one or many destination sectors where the UE is most likely to reside based on location pattern information.

It should be noted that the node herein may be a logical entity with its functions distributed amongst two or more physical entities.

### BRIEF DESCRIPTION OF THE DRAWING

In the accompanying drawings, the preferred embodiment of the invention and preferred methods of practicing the invention are illustrated in which:

FIG. 1 is a block diagram of a node of the present invention.

FIG. 2 is a schematic representation of the node of the network having a UE.

FIG. 3 is an example of the message flow between the node of the network and the UE.

FIG. 4 is another schematic representation of the network having a UE.

### DETAILED DESCRIPTION

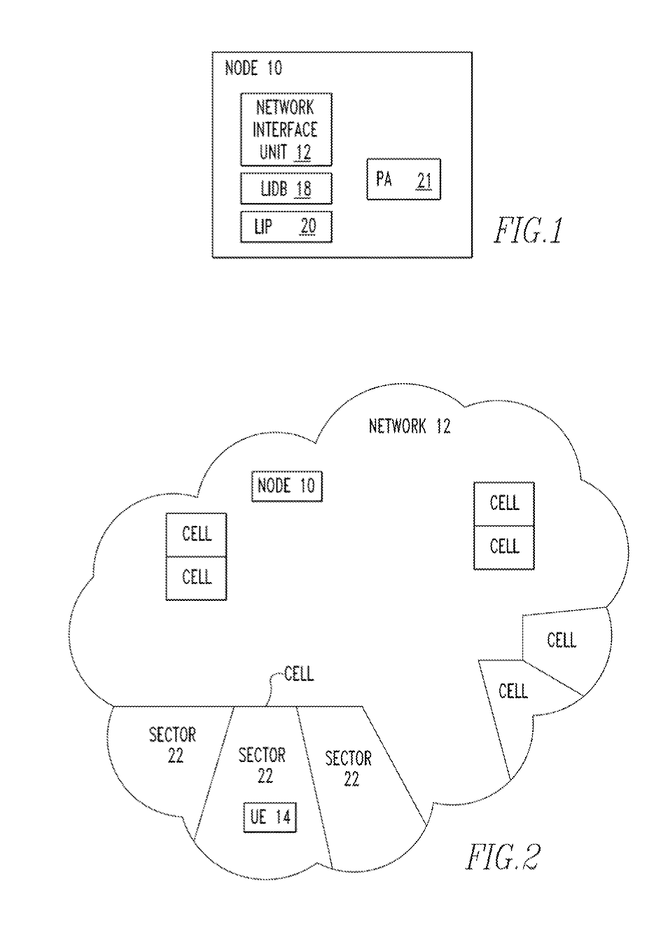

Referring now to the drawings wherein like reference numerals refer to similar or identical parts throughout the several views, and more specifically to FIGS. 1, 2 and 4 thereof, there is shown a node 10 of a wireless telecommunications network 12 having a UE 14. The node 10 comprises a network 12 interface unit which receives and records each instance of a wireless protocol message, from the UE 14, to form a connection in the network 12 (e.g., a Connection Request message) or to update the network 12 of its location (e.g., a Location Update message), including time, date, and one or more sectors 22 of the UE 14 when the UE 14 attempt is made. The node 10 comprises a Location Intelligence Database (LIDB) 18, in which the recorded UE 14 location information for the message from the UE 14 over time is stored. The node 10 comprises a Location Intelligence Processor (LIP) 20, which aggregates the information stored in the LIDB 18 to form a pattern of UE 14 location information by time, date, and sector within the wireless network 12.

A cellular wireless network 12 usually contains many cells, one or more nodes. such as base transceiver stations (BTSs) are located at each cell. A contiguous collection of such cells forms subnetwork, and in turn many such subnetwork forms the entirety of the wireless network. Usually a cell is further subdivided into sectors 22, which may allow the BTS to transmit in a limited direction, usually 60-120 degrees; thus there are as many as 3 or 6 such sectors in a cell.

The location of the UE 14 may include one or more sectors 22 from which the UE 14 sends the wireless protocol message to the wireless network 12 or the one or more sectors 22 included in the message. The wireless protocol message may include protocols defined in a wireless technology standard of at least one of 3GPP2 CDMA, 3GPP2 CDMA EVDO, 3GPP UMTS, 3GPP UMTS HSPA, IEEE802.16 WiMAX, and 3GPP LTE. The information stored in the LIDB 18 may be indexed by time slot associated with when, i.e., the time of the day and the day, the wireless protocol message is received from the UE 14.

The time slot may include time of day of the stored connection attempt information and has a granularity of multiples of minutes. The time slot may include a day of the stored connection attempt information and has a granularity of individual days from Sunday to Saturday, or a granularity of Sundays, workdays, and Saturdays. The day of the stored connection attempt information may include defined holidays, statutory holidays, and special national and regional days separately.

The wireless protocol message received from the UE 14 may be a UE 14 initiated connection attempt, a network 12 initiated connection attempt, or a message from the UE 14 which update its location, status, or measurements to the wireless network 12. The LIP 20 may aggregate the UE 14 location information where the UE 14 location information is categorized into separate bins, each bin is indexed by the time slot, and each bin contains one or more sectors 22 where a wireless protocol message had been sent by the UE 14 to the wireless network 12. Each sector contained in a bin may contain a counted number that corresponds to a number of wireless protocol messages received from the UE 14 at a designated time slot since the UE 14 had registered in the wireless network 12, or it had previously registered, or since it had become known.

The present invention pertains to a node 10 of a wireless telecommunications network 12 having a UE 14. The node 10 comprises a network interface unit 16 which receives and records each instance of a wireless protocol message, from the UE 14, to form a connection in the network 12 or to update the network 12 of its location, including time, date, and one or more sectors 22 of the UE 14 when the UE 14 attempt is made. The node 10 comprises a Location Intelligence Database (LIDB) 18, in which UE 14 location information is stored and indexed to a time slot. The node 10 comprises a Paging Agent processing unit 21 (PA), which produces a page request for the UE 14 that is sent from the network interface unit 16 to the UE 14 through the network 12 to one or many destination sectors 22 where the UE 14 is most likely to reside based on location pattern information.

The record in the LIDB 18 may be indexed by the time slot where the UE 14 location information is categorized into separate bins, each bin is indexed by the time slot, and each bin contains one or more sectors 22, each of which contains a counted number that corresponds to the absolute occurrences of the UE 14 in that sector at the time slot. The PA 21 may decide that it has accumulated sufficient UE 14 location intelligence in the LIDB 18 by a statistical function: f₁(LIDB(UE_id)), whenever each time slot has counted at least one or more occurrences. The PA 21 may compute the sectors 22, as a function of the LIDB 18 content f₂(LIDB(UE_id),TimeSlot), to which a page request is sent.

The sectors 22 may include one or more sectors 22 where the UE 14 had been located and the count in the LIDB 18 is non-zero. The sectors 22 may include a list of sectors M, yielding

$$Max ( ( {\sum }_{m ∈ M} m \cdot {p}^{m} ) ) / ( {\sum }_{n ∈ N} n \cdot {p}^{n} ) ) ,$$

where M⊂N is the full set of sectors indexed to that UE_id in the LIDB 18, and M is restricted by either the number of elements or as a percentage of N, which is configurable within the wireless system.

The sectors 22 may include a list of sectors M, which are produced from other variants of statistical functions of parameters M, N, and p(i) where p(i) is the probability of i instance. The PA 21 may send a second or third page request if the previous pages had not been responded to by the UE 14 in the selected sectors 22, the third page request contains more sectors 22 from the LIDB 18 using Intelligent Paging, or network 12 wide paging, subnetwork wide paging, zone based paging, distance based paging, or last location update based paging.

In the operation of the invention, human activity usually forms a pattern between fixed locations. Once the pattern is established the location of the UE 14 is highly predictable with a limited number of attributes, including day, time, and location. This invention captures such location intelligence information, and utilizing it to predict the precise location of a UE 14 at the granularity of a cell or sector.

The location intelligence of the UE 14 is obtained through a case-based learning process. Initially the wireless system has no knowledge of the user, but over time, this knowledge is learned and accumulated in the database of each case of the UE 14 access attempt to the network 12. The UE's location is indexed to UE's ID within the system, the day, time of the day, and access trigger, i.e., whether it is UE 14 attempted or network 12 attempted connection, and other attributes, e.g., QoS supported or not.

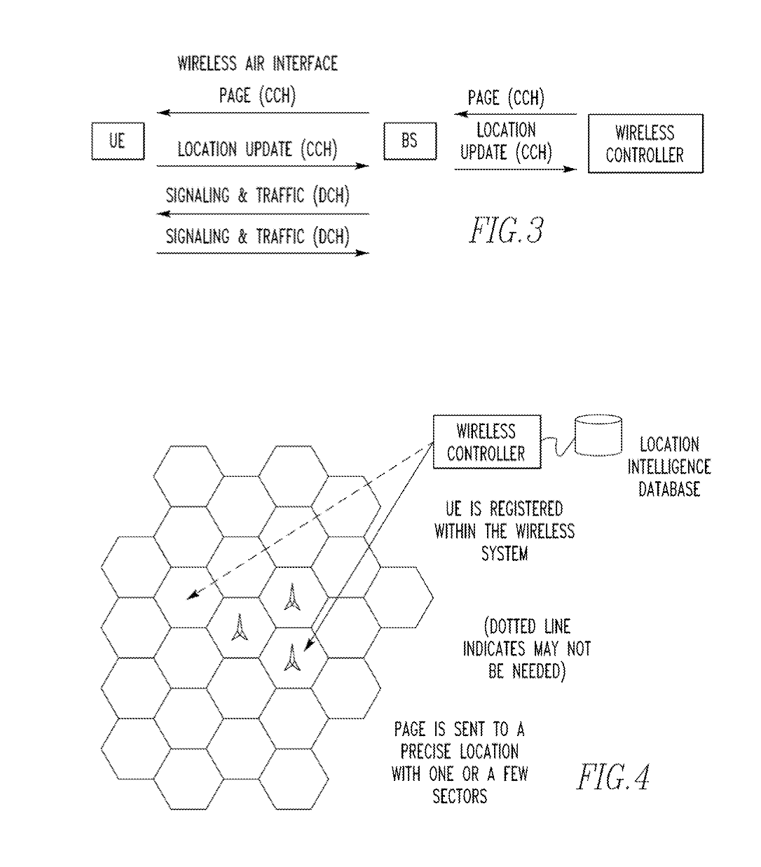

Once the wireless system has a sufficient amount of location intelligence in its database. Every network 12 attempted connection of the UE 14 is filtered by the data captured. The first page from the network 12 will be precisely addressed to the one or few sectors 22 of the filtered location as shown in FIG. 4.

The algorithm that results is self-learning in that each page attempt, capturing such information of whether a page succeeds, on which page attempt it succeeds, and the sectors 22 included in the page. The consolidated location intelligence is also then re-applied to the subsequent page requests.

When a UE 14 registers in the current wireless system, the UE's Location Intelligence Database (LIDB) 18 is initialized to seven daily entries. With each UE 14 initiated access attempt, i.e., a message from the UE 14 to the wireless system, in any sector, the wireless system records the day, the hour of the day, and the sector where the attempt came from.

With each network 12 initiated access attempt, i.e., a message from the UE 14 in response to a page of the wireless system, the wireless system records the day, the hour, and the sector where the page response is received.

Additionally, in both cases the wireless system may also record the associated sectors 22. The sector is usually indicated by the sector ID, or the pilot or reference ID. The associated sectors 22 are such IDs included in the location update, route update, or tracking update messages or parameters of the UE 14 messages. The day and hour are examples of the time and location based indexing. Other indexing granularity is also possible. The paging scope of the first page attempt is selected as the following.

If the LIDB 18 does not have sufficient location intelligence data, the page is sent over to the sectors 22 selected by a default paging method. The intelligent paging method can be jointly used with a number of other paging methods, for example, last-known location based paging, distance based paging, or simply across all sectors 22.

The decision of whether the system has sufficient location intelligence is a statistical function of the content of the LIDB 18, i.e., f₁(LIDB(UE_id)). For example, in the simplest case, f₁ is the total number of cases in the LIDB 18 for that UE_id. If the LIDB 18 has sufficient location intelligence data, the wireless system determines the sector or sectors 22 as a separate function of the LIDB f₂(LIDB(UE_id),day,time) which yields a list of sectors 22 within the wireless system. Note f₂ may also include other parameters other than day and time. This is the first stage of the process, i.e., the first page attempt.

In the simplest case, f₂ yields a single sector where the UE 14 is most likely to reside. With a more complex interpretation of the function f₂ it results in a list of sectors M, yielding

$$Max ( ( {\sum }_{m ∈ M} m \cdot {p}^{m} ) ) / ( {\sum }_{n ∈ N} n \cdot {p}^{n} ) ) ,$$

where M⊂N is the full set of sectors indexed to that UE_id in the LIDB 18, and M is restricted by either the number of elements or as a percentage of N, which is configurable within the wireless system.

In the second stage of the process, i.e., the second page attempt, the function f₂ is relaxed to increase the scope of the paging attempt. For example, the set of pages includes all sectors 22 in the set N. In a subsequent page attempt, the page may be sent to all sectors 22 within the wireless system.

The intelligent paging method allows wireless systems to exploit regularity and predictability in human activities. It permits the page to be sent more precisely to where the UE 14 is most likely located with the fewer pages throughout the system. This allows the DL transmission resources in the system overall to be saved for more productive use such as transmitting actual user data.

### ABBREVIATIONS

3GPP 3rd Generation Project Partnership

3GPP2 3rd Generation Project Partnership 2

BTS Base Transceiver Station

CDMA Code Division Multiple Access

DL Downlink

DRC Data Rate Control

FDMA Frequency Division Multiple Access

GPS Global Positioning System

HRPD High Rate Packet Data

HSDPA High Speed Downlink Packet-Data Access

LIDB Location Intelligence Database

LTE Long Term Evolution (3GPP)

MIMO Multiple-In Multiple-Out

OFDMA Orthogonal Frequency Division Multiple Access

PN Pseudo-sequence Number

PSM Phase Shift Module

RF Radio Frequency

RxM Receiver Module

SC-FDMA Single Carrier—Frequency Division Multiple Access

TDMA Time Division Multiple Access

TRM Transmitter/Receiver Module

TxM Transmitter Module

UE User Equipment

UL Uplink

UMTS University Mobile Telecommunications System

WIMAX Worldwide Interoperability for Microwave Access

WCDMA Wide-Band CDMA

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A node of a wireless telecommunications network having a User Equipment (UE), the node comprising:
a network interface unit which receives a plurality of wireless protocol messages from the UE, the wireless protocol messages including UE location information;
a Location Intelligence Database (LIDB), in which the UE location information included in the messages received from the UE over time is stored;
a Location Intelligence Processor (LIP), which aggregates the information stored in the LIDB to form a pattern of UE location information by time, date, and sector within the wireless network; and
a processing unit that determines where in the wireless network the UE is most likely to reside based on the pattern of UE location information.

2. The node of claim 1 wherein the UE location information included in each of the wireless protocol messages includes one or more sectors from which the UE sends the wireless protocol message.

3. The node of claim 1 wherein the wireless protocol messages include protocols defined in a wireless technology standard of at least one of 3GPP2 CDMA, 3GPP2 CDMA EVDO, 3GPP UMTS, 3GPP UMTS HSPA, IEEE802.16 WiMAX, and 3GPP LTE.

4. The node of claim 1 wherein the information stored in the LIDB is indexed by time slot associated with when the each of the wireless protocol messages is received from the UE.

5. The node of claim 4 wherein the time slot includes time of day of the stored UE location information and has a granularity of multiples of minutes.

6. The node of claim 5 wherein the time slot includes a day of the stored UE location information and has a granularity of individual days from Sunday to Saturday, or a granularity of Sundays, workdays, and Saturdays.

7. The node of claim 6 wherein the day of the stored UE location information includes defined holidays, statutory holidays, and special national and regional days separately.

8. The node of claim 1 wherein the wireless protocol messages received from the UE include at least one of: a UE initiated connection attempt, a network initiated connection attempt, or a message from the UE which updates a location, a status, or measurements to the wireless network.

9. The node of claim 4 wherein the LIP aggregates the UE location information where the UE location information is categorized into separate bins, each bin is indexed by the time slot, and each bin is configured to contain one or more sectors where a wireless protocol message had been sent by the UE to the wireless network.

10. The node of claim 9 wherein each sector contained in a bin contains a counted number that corresponds to a number of times wireless protocol messages had been received from the UE at a designated time slot since the UE had registered in the wireless network, or it had previously registered, or since it had become known.

11. A node of a wireless telecommunications network having a User Equipment (UE), the node comprising:
a network interface unit which receives and records each instance of a wireless protocol message, from the UE, to form a connection in the network, or to update the network of its location, or to report system measurements including time, date, and one or more sectors of the UE when the UE attempt is made;
a Location Intelligence Database (LIDB), in which UE location information is stored and indexed to a time slot; and
a Paging Agent processing unit (PA), which produces a page request for the UE that is sent from the network interface unit to the UE through the network to one or many destination sectors where the UE is most likely to reside based on location pattern information.

12. The node of claim 11 wherein the record in the LIDB is indexed by the time slot where the UE location information is categorized into separate bins, each bin is indexed by the time slot, and each bin contains one or more sectors, each of which contains a counted number that corresponds to the absolute occurrences of the UE in that sector at the time slot.

13. The node of claim 11 wherein the PA decides that it has accumulated sufficient UE location intelligence in the LIDB by a statistical function: f₁(LIDB(UE_id)), whenever each time slot has counted at least one or more occurrences.

14. The node of claim 11 wherein the PA computes the sectors, as a function of the LIDB content f₂(LIDB(UE_id),TimeSlot), to which a page request is sent.

15. The node of claim 12 wherein the sectors include one or more sectors where the UE had been located and the count in the LIDB is non-zero.

16. The node of claim 12 wherein the sectors include a list of sectors M, yielding
$$Max ( ( {\sum }_{m ∈ M} m \cdot {p}^{m} ) ) / ( {\sum }_{n ∈ N} n \cdot {p}^{n} ) ) ,$$
where M⊂N is the full set of sectors indexed to that UE_id in the LIDB, and M is restricted by either the number of elements or as a percentage of N, which is configurable within the wireless system.

17. The node of claim 12 wherein the sectors include a list of sectors M, which are produced from other variants of statistical functions of parameters M, N, and p(i) where p(i) is the probability of i instance.

18. The node of claim 11 wherein the PA sends a second page request if the previous pages had not been responded to by the UE in the selected sectors, the second page request contains more sectors from the LIDB using Intelligent Paging, or is combined with network wide paging, subnetwork wide paging, zone based paging, distance based paging, or last location update based paging.

19. The node of claim 18 wherein the PA sends a third page request if the first and second pages have not been responded to by the UE in the selected sectors, the third page request contains more sectors from the LIDB using Intelligent Paging, or is combined with network wide paging, subnetwork wide paging, zone based paging, distance based paging, or last location update based paging.

20. The node of claim 14 wherein the PA determines the TimeSlot where the TimeSlot corresponds to the current time.

21. The node of claim 14 wherein the PA determines the TimeSlot where the current time is not within a TimeSlot indexed by the LIP and the TimeSlot is calculated as a function of the current time f₃(CurrentTime).

22. The node of claim 21 wherein the PA determines the TimeSlot by the function f₃(CurrentTime) which yields a closest TimeSlot to the current time, including TimeSlotₛ<CurrentTime and TimeSlot_{g}>CurrentTime.

23. The node of claim 22 wherein the PA determines the sectors to which the page request is sent, as the union of f₂(LIDB(UE_id),TimeSlotₛ) and f₂(LIDB(UE_id),TimeSlot_{g}).
